(19) United States
(12) Patent Application Publication
(10) Pub. No.: US 2026/0175505 A1
(43) Pub. Date: Jun. 25, 2026

(54) SYSTEM AND METHOD FOR BLOW MOLDING PLATE COMPONENTS FOR ARTICLES OF FOOTWEAR

(71) Applicant: NIKE, Inc., Beaverton, OR (US)

(72) Inventors: Jeremy D. Walker, Portland, OR (US); James M.F. Webster, Tigard, OR (US)

(73) Assignee: NIKE, Inc., Beaverton, OR (US)

(21) Appl. No.: 19/427,132

(22) Filed: Dec. 19, 2025

Related U.S. Application Data
(60) Provisional application No. 63/737,101, filed on Dec. 20, 2024.
(60) Provisional application No. 63/884,933, filed on Sep. 19, 2025.

(51) Int. Cl. B29C 49/04; B29C 49/22; B29D 35/14; B29L 31/50

(52) U.S. Cl. CPC B29C 49/04104; B29C 49/04116; B29C 49/22; B29D 35/142; B29D 35/148; B29K 2995/0026; B29K 2995/0029; B29L 2031/504

(57) ABSTRACT

A blow molding system includes an extrusion system with a first extruder suitable to extrude a first material to a manifold having an end die to form a first layer of a parison. The system also includes one or more interruption elements, each disposed within the manifold between the first extruder and the end die. Each interruption element is moveable between a retracted position spaced apart from the first material and an extended position that penetrates the flow of the first material to form a respective gap in the parison. The system further includes a mold assembly with a mold chamber defining a profile of at least one mold plate, which defines a mold cavity and includes a mold opening suitable to receive the parison from the end die of the first extruder.

### CROSS REFERENCE TO RELATED APPLICATIONS

This application claims priority under 35 U.S.C. § 119 (e) to U.S. Provisional Application No. 63/884,933, filed on Sep. 19, 2025 and U.S. Provisional Application No. 63/737,101, filed on Dec. 20, 2024. The disclosures of these prior applications are considered part of the disclosure of this application and are hereby incorporated by reference in their entirety.

### FIELD

The present disclosure relates generally to a system for molding a sole plate for an article of footwear, and more particularly, to a system for simultaneously blow molding a plurality of sole plates for articles of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may include a sole plate formed of a rigid or semi-rigid material that provides rigidity and energy distribution across the sole structure. The sole plate may be provided with one or more types of traction elements for maximizing engagement with a ground surface. In some cases, the traction elements may be fixed to the outsole plate or integrally molded with the sole plate. Sole plates are typically manufactured using injection molding processes.

### DRAWINGS

The drawings described herein are for illustrative purposes only of selected configurations and not all possible implementations, and are not intended to limit the scope of the present disclosure.

FIG. 1 is a schematic view showing a cross section of an example configuration of a blow molding system in accordance with the principles of the present disclosure;

FIG. 2A is a schematic view showing the cross section of the blow molding system of FIG. 1, where a molding material is extruded into an end die of the blow molding system;

FIG. 2B is a cross-sectional view of the blow molding system of FIG. 2A, taken along Line 2B-2B of FIG. 2A;

FIG. 2C is a cross-sectional view of the blow molding system of FIG. 2A, taken along Line 2C-2C of FIG. 2A;

FIG. 2D is a cross-sectional view of the blow molding system of FIG. 2A, taken along Line 2D-2D of FIG. 2A;

FIG. 2E is a cross-sectional view of the blow molding system of FIG. 2A, taken along Line 2E-2E of FIG. 2A;

FIG. 3A is a schematic view showing the cross section of the blow molding system of FIG. 2A, where the molding material is partially extruded into a mold as a parison;

FIG. 3B is a cross-sectional view of the blow molding system of FIG. 3A, taken along Line 3B-3B of FIG. 3A;

FIG. 3C is a cross-sectional view of the blow molding system of FIG. 3A, taken along Line 3C-3C of FIG. 3A;

FIG. 3D is a cross-sectional view of the blow molding system of FIG. 3A, taken along Line 3D-3D of FIG. 3A;

FIG. 3E is a cross-sectional view of the blow molding system of FIG. 3A, taken along Line 3E-3E of FIG. 3A;

FIG. 3F is a cross-sectional view of the blow molding system of FIG. 3A, taken along Line 3F-3F of FIG. 3A;

FIG. 4 is a schematic view showing the cross section of the blow molding system of FIG. 2A, where the molding material is fully extruded into a mold as the parison;

FIG. 5 is a schematic view showing the cross section of the blow molding system of FIG. 1, where a mold assembly is moved to a closed configuration;

FIG. 6 is a schematic view showing the cross section of the blow molding system of FIG. 1, wherein the parison is expanded into mold cavities of the mold;

FIG. 7 is a schematic view showing the cross section of the blow molding system of FIG. 1, wherein the mold is opened for removal of a molded article;

FIG. 8 is a perspective view of the molded article of FIG. 5, showing a step of separating molded article sections;

FIG. 9 is a perspective view of the separated molded article sections of FIG. 8;

FIG. 10 is a schematic view showing a cross section of another example configuration of a blow molding system in accordance with the principles of the present disclosure;

FIG. 11A is a cross-sectional view of the blow molding system of FIG. 10, taken along Line 11-11 of FIG. 10 and showing a parison in an extruded state prior to expansion;

FIG. 11B is a cross-sectional view of the blow molding system of FIG. 10, taken along Line 11-11 of FIG. 10 and showing the parison in an expanded state;

FIG. 12 is a perspective view of a molded article formed using the molding system of FIG. 10;

FIG. 13A is a perspective view of a rinsing system with the molded article in a first state including a separation flange;

FIG. 13B is a perspective view of the rinsing system with the molded article in a second state with the separation flange removed;

FIG. 14 is a perspective view of the separated molded article of FIG. 13A; and

FIG. 15 is a perspective view of an article of footwear equipped with a sole component according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a blow molding system. The system includes an extrusion system with a first extruder suitable to extrude a first material to a manifold having an end die to form a first layer of a parison. The system also includes one or more interruption elements, each disposed within the manifold between the first extruder and the end die. Each interruption element is moveable between a retracted position spaced apart from the first material and an extended position that penetrates the flow of the first material to form a respective gap in the parison. The system further includes a mold assembly with a mold chamber defining a profile of at least one mold plate, which defines a mold cavity and includes a mold opening suitable to receive the parison from the end die of the first extruder.

Aspects of the disclosure may include one or more of the following optional features. In some aspects, the system further comprises a second extruder suitable to extrude a second material into the one or more gaps. In some examples, the second material is a water-soluble material, a transparent or translucent material, or has a lower durometer than the first material. In some implementations, the interruption elements include a first and second interruption element to form first and second gaps, and the system may further include a third extruder to extrude a third material into one of the gaps. In some configurations, the mold chamber includes a plurality of mold cavities, each defining a profile of at least one sole component of an article of footwear. In some aspects, the system includes a fourth extruder for extruding a fourth material to form a second layer of the parison concentric with the first layer. In some examples, the one or more interruption elements are aligned with an intermediate portion of the mold cavity of the at least one mold plate.

An aspect of the disclosure provides a method. The method includes providing a first material from a first extruder to a manifold to form a first layer of a parison flowing through the manifold and partially interrupting a flow of the first layer through the manifold to form a gap in it. The method further includes providing a second material from a second extruder into the gap formed in the first layer and extruding the parison, which includes the first and second materials, into a mold chamber. The mold chamber has an opening at one end that receives the parison and includes at least one mold cavity facing the chamber that defines a profile of at least one sole component of an article of footwear.

Aspects of the disclosure may include one or more of the following optional features. In some aspects, the gap is aligned with an intermediate portion or a peripheral portion of the at least one mold cavity. In some examples, interrupting the flow includes moving an interruption element from a retracted position spaced apart from the first layer to an extended position penetrating the first layer. In some implementations, the second material is a water-soluble material, a transparent or translucent material, or has a lower durometer than the first material. In some configurations, the method further comprises providing a third material from a third extruder to the manifold to form a second layer of the parison concentric with the first layer. In some aspects, interrupting the flow of the first layer includes interrupting a first portion and a second portion of the flow to define a first gap and a second gap, and the second material is provided into each of the gaps.

The present disclosure provides a system and method for blow molding polymer components for articles of footwear, and particularly, multi-layer sole plates for articles of footwear. Conventionally, sole plates and other polymeric components of footwear are manufactured using injection molding processes, or in some instances, additive manufacturing (e.g., three-dimensional printing). While suitable, injection molding processes can be relatively costly due to the complexity of molds and molding materials. Additionally, injection molding processes may limit the types of materials that can be used, as some chemistries of materials are not compatible with each other when combined in an injection molding process. Further, these processes can be time and labor intensive. Blow molding is a low-cost and efficient manufacturing method that enables lightweight products to be manufactured that can be mono-layer or multi-layer, thereby enabling unique material combinations to be achieved in a single process. Additionally, molds associated with blow molding systems are typically less expensive relative to molds associated with injection molding processes. As discussed herein, the molds used with blow molding processes may include multiple mold plates for forming a plurality of sole plates simultaneously. Use of extruded materials in a blow molding process also enables the option of incorporating recycled content or foamed layers within the center layers of a sole plate, thereby improving sustainability while maintaining desired aesthetics and performance qualities.

The details of one or more implementations of the disclosure are set forth in the accompanying drawings and the description below. Other aspects, features, and advantages will be apparent from the description, the drawings, and the claims.

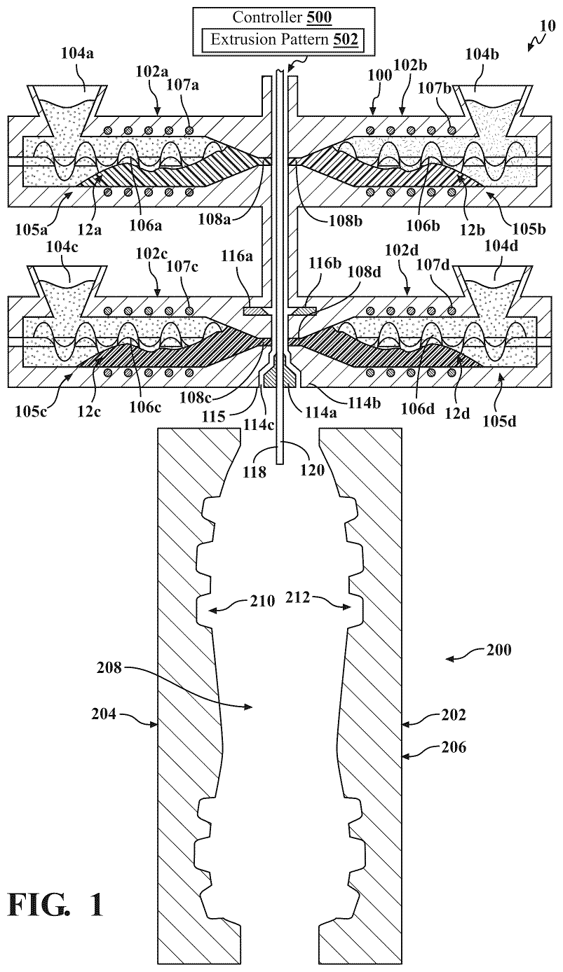

Referring to FIGS. 1-7, a blow molding system 10 is provided according to an example of the present disclosure. The blow molding system 10 includes an extrusion system 100 and a mold system 200 configured to produce a blow-molded article 300 including one or more footwear components. For example, in some configurations, the footwear components may include a plurality of sole plates 306, 308 for use in manufacturing of an article of footwear 1000 (FIG. 15). Thus, the plurality of the sole plates 306, 308 can be simultaneously formed by the blow molding system 10. In alternative configurations, the footwear component may include other components or portions of an article of footwear, such as heel counters, integral sole plates, integral heel counter units, or any other practicable footwear component that may be produced using the blow molding system. The extrusion system 100 may also include a controller 500 configured with a predetermined extrusion pattern 502. The controller 500 may be configured to execute one or more extruders 102a-102d of the extrusion system 100 to, ultimately, produce the blow-molded article 300, described herein.

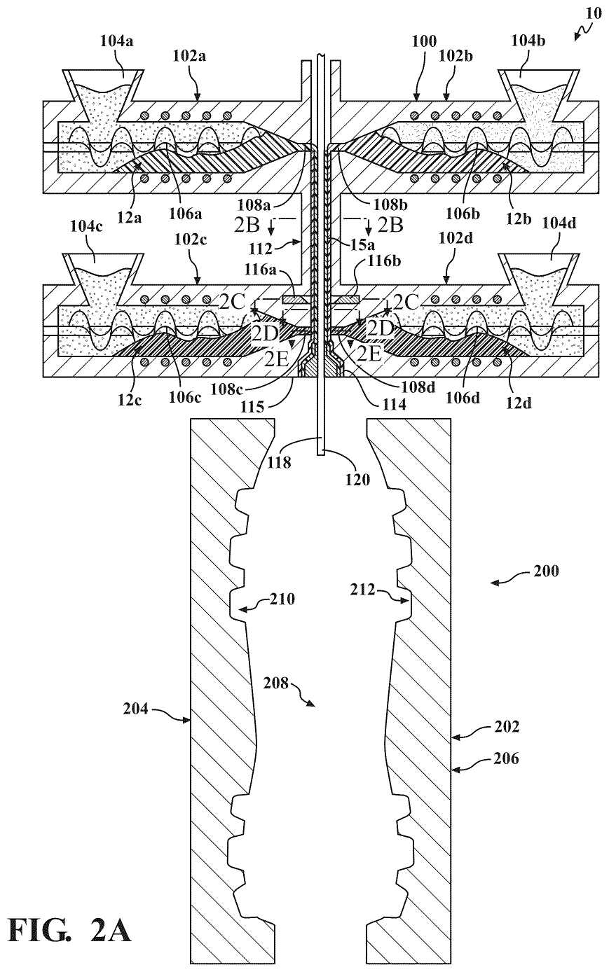

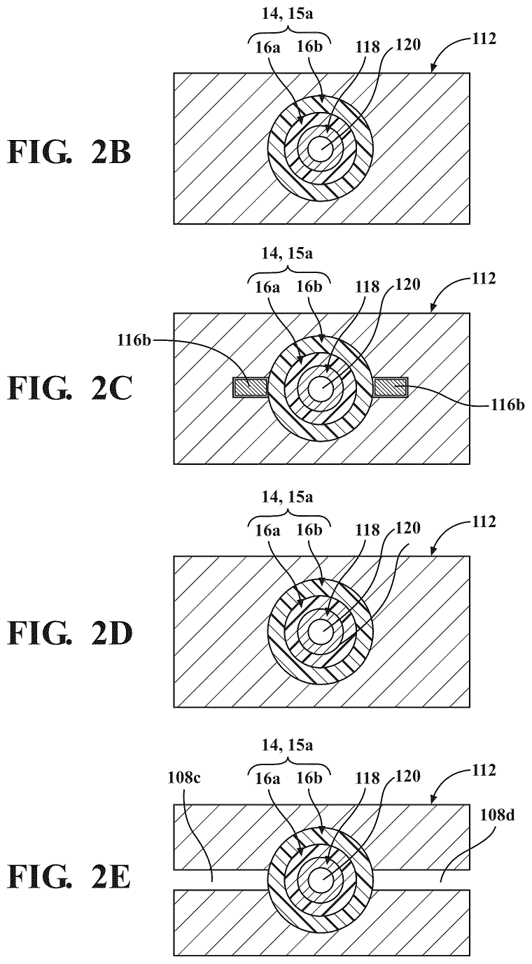

Referring to FIGS. 1 and 2A, the extrusion system 100 includes one or more extruders 102a-102d, including a first extruder 102a configured to extrude a first mold material 12a, a second extruder 102b configured to extrude a second mold material 12b, a third extruder 102c configured to extrude a third mold material 12c, and a fourth extruder 102d configured to extrude a fourth mold material 12d. While the illustrated example is provided with first, second, third, and fourth extruders 102a-102d, for the sake of clarity, it should be appreciated that the extrusion system 100 may include less extruders or additional extruders as desired.

The first extruder 102a includes a first hopper 104a for receiving the first mold material 12a in a raw form, such as, but not limited to, in a pellet form, powder form, shaving form, molten form or any other practicable raw form of the first material 12a. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first material 12a.

The second extruder 102b includes a second hopper 104b for receiving the second material 12b in a raw form, such as, but not limited to, in a pellet form, powder form, shaving form, molten form or any other practicable raw form of the second material 12b. The second extruder 102b further includes an extruder barrel 105b including a second extruder screw 106b and a heating element 107b for heating the second material 12b to a molten state. The extruder barrel 105b includes a second nozzle 108b disposed at an end of the second extruder screw 106b for receiving the molten second material 12b.

The third extruder 102c includes a third hopper 104c for receiving the third material 12c in a raw form, such as, but not limited to, in a pellet form, powder form, shaving form, molten form or any other practicable raw form of the third material 12c. The third extruder 102c further includes an extruder barrel 105c including a third extruder screw 106c and a heating element 107c for heating the third material 12c to a molten state. The extruder barrel 105c includes a third nozzle 108c disposed at an end of the third extruder screw 106c for receiving the molten third material 12c.

The fourth extruder 102d includes a fourth hopper 104d for receiving the fourth material 12d in a raw form, such as, but not limited to, in a pellet form, powder form, shaving form, molten form or any other practicable raw form of the fourth material 12d. The fourth extruder 102d further includes an extruder barrel 105d including a fourth extruder screw 106d and a heating element 107d for heating the fourth material 12d to a molten state. The extruder barrel 105d includes a fourth nozzle 108d disposed at an end of the fourth extruder screw 106d for receiving the molten fourth material 12d.

Each of the nozzles 108a-108d of the extruders 102a-102d may include or be in communication with a manifold 112, which provides a passageway for the respective materials 12a-12d to an end die 114 of the extrusion system 100. The end die 114 includes an inner portion 114a and an outer portion 114b. The inner portion 114a is received by the outer portion 114b and is moveable relative to the outer portion 114b. For example, the inner portion 114a may be attached or otherwise operably coupled to a screw or other adjustment mechanism to raise and lower the inner portion 114a relative to the outer portion 114b of the end die 114. The inner portion 114a is at least partially spaced apart from the outer portion 114b to define a gap 114c at the end die 114. The gap 114c may be selectively increased or decreased depending on the position of the inner portion 114a relative to the outer portion 114b to adjust a thickness of the materials 12a-12d extruded at the end die 114.

The nozzles 108a-108d are configured to introduce the materials 12a-12d to the manifold 112 in a sequential manner, whereby the first material 12a and the second material 12b are provided to the end die 114 upstream of the third material 12c and the fourth material 12d. The second material 12b is layered upon an outer surface of the first material 12a to form an inner layer 16a and an outer layer 16b of a coextruded parison 14. As discussed in greater detail below, the third material 12c and the fourth material 12d may be selectively provided to fill interruptions or gaps 17a, 17b formed in the inner layer 16a and/or the outer layer 16b of the parison 14.

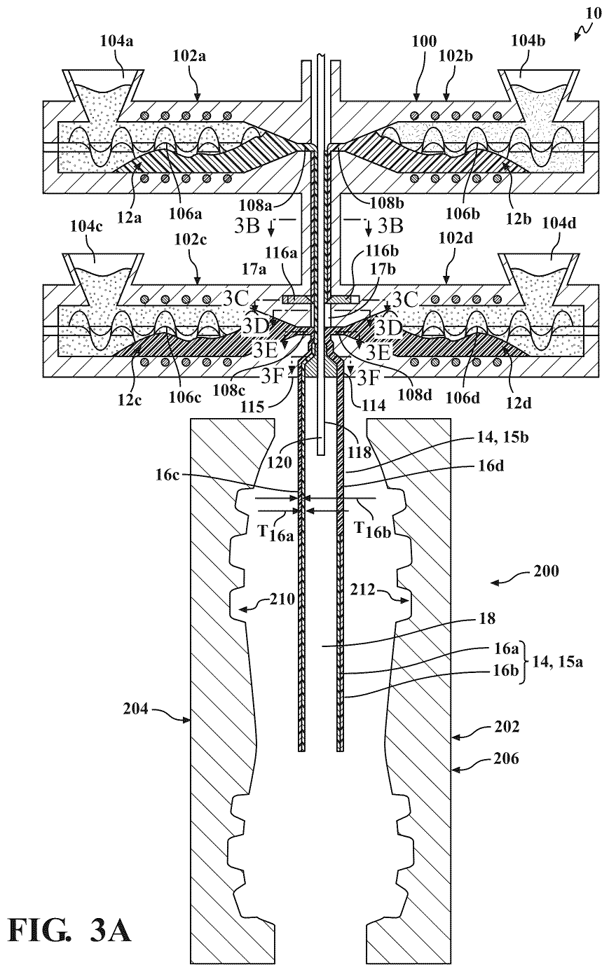

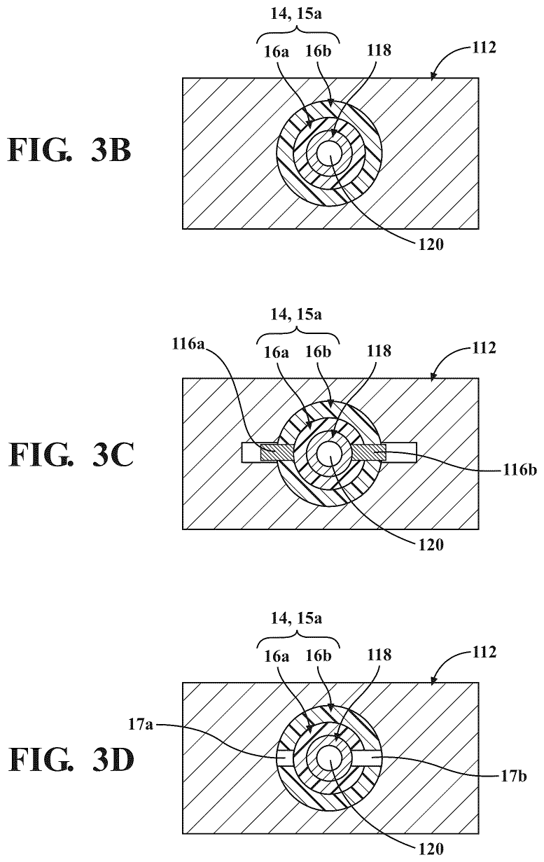

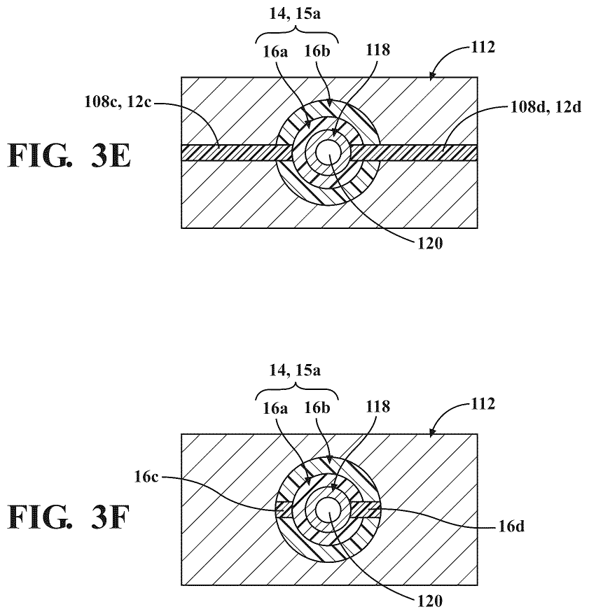

With reference to FIGS. 1-3A, one or more interruption elements 116a, 116b are positioned within the manifold 112 and may be operably controlled via the controller 500 as part of the execution of the extrusion pattern 502. The interruption elements 116a, 116b are operable between a retracted position (FIG. 2A) and an extended position (FIG. 3A). For example, the interruption elements 116a, 116b are in the retracted position when the first material 12a and the second material 12b are being extruded without the gaps 17a, 17b. The interruption elements 116a, 116b are moved to the extended position to form one or more interruptions or gaps 17a, 17b in the first material 12a (i.e., the inner layer 16a) and/or the second material 12b (i.e., the outer layer 16b). While the first material 12a and the second material 12b may continue to flow around the interruption element 116a, 116b, the interruption elements 116a, 116b define the interruptions or gaps 17a, 17b in which the third material 12c and/or the fourth material 12d may be deposited. In some configurations, the extrusion system 100 may be configured with multiple interruption elements 116a, 116b and additional extruders to introduce materials at different segments or sections of the upstream materials depending on the desired configuration of the molded article 300.

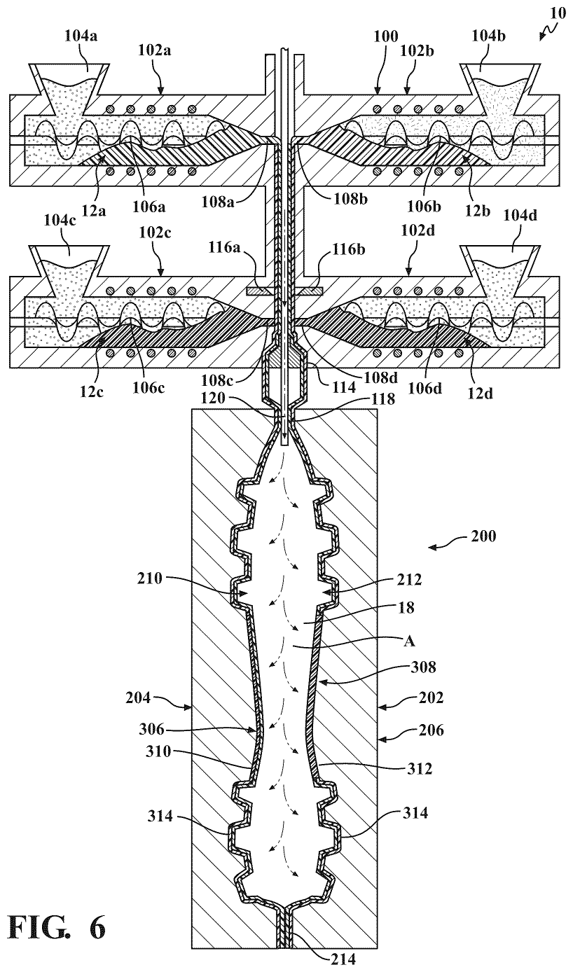

Referring still to FIGS. 1-3, the extrusion system 100 includes a blow pin 118 positioned within the end die 114 and extending from an outlet end 115 of the end die 114. The blow pin 118 is configured to extend within an interior cavity 18 of the parison 14 and into the mold system 200. While the illustrated example shows the layers 16a-16d of the parison 14 being directly adjacent to the blow pin 118, other extrusion systems 100 may be configured such that the layers 16a-16d of the parison 14 are spaced radially outwardly from the blow pin 118 and may be separated from the blow pin 118 by the inner portion 114a of the end die 114 (e.g., an annular spacer). The blow pin 118 is configured to receive a pressurized fluid (e.g., air) and to inject the pressurized fluid into the interior cavity 18 of the parison 14 to expand the parison 14 within the mold system 200, as described below with respect to FIG. 6.

As set forth above, the extrusion system 100 is configured to extrude four materials 12a-12d. While the materials 12a-12d may be the same, an advantage of the extrusion system 100 is that it allows different materials to be coextruded as unique layers of the parison 14. For example, the layers 16a, 16b of the parison 14 can comprise an elastomeric material that includes one or more thermoplastic polymers and/or one or more cross-linkable polymers, while the third and fourth materials 12c, 12d may comprise a polyvinyl alcohol material. In other instances, each of the materials 12a-12d may comprise the elastomeric material.

The third material 12c and the fourth material 12d are designed to provide differing aesthetic and/or performance characteristics than the first material 12a and the second material 12b. For example, the third material 12c and the fourth material 12d may have different colors or transparencies than the first material 12a and the second material 12b to provide color inserts and/or viewing windows along the finished sole plates 306, 308. Additionally or alternatively, the third material 12c and the fourth material 12d may be configured to provide different functional properties than the first material 12a and the second material 12b.

The materials 12a-12d can each be produced from an elastomeric material that includes one or more thermoplastic polymers and/or one or more cross-linkable polymers. In an aspect, the elastomeric material can include one or more thermoplastic elastomeric materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C—O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4,4′-diisocyanate (DDDI), 4,4′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

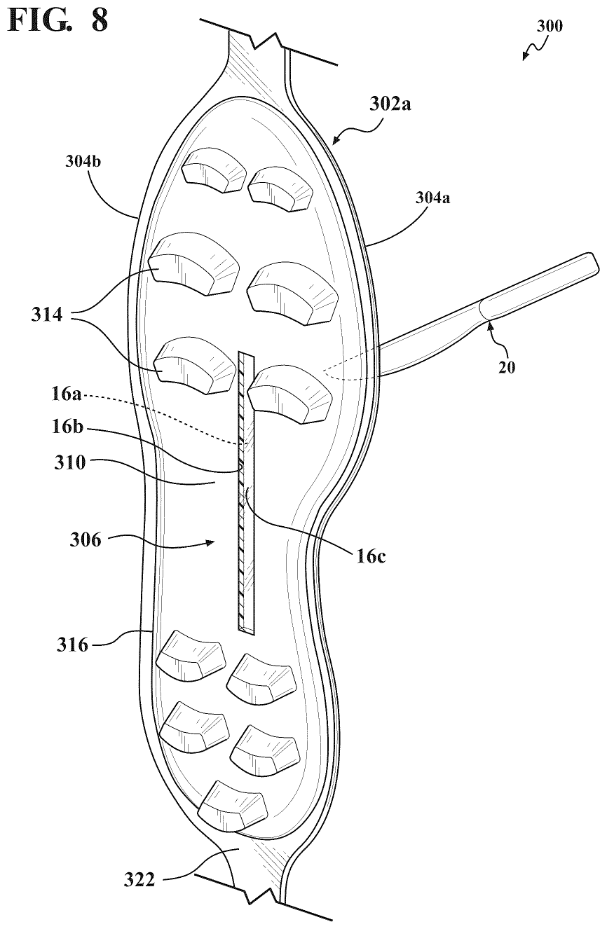

In some examples, where a first material 12a and a second material 12b are selected that are incompatible (e.g., do not naturally bond to each other in a molten state), the extrusion system 100 may include an intermediate extruder configured to extrude an intermediate adhesive material for bonding the first material 12a to the second material 12b. Thus, the parison 14 may include two or more layers (multilayer extrusion) joined by an adhesive. Additionally or alternatively, the extrusion system 100 may include one or more extruders configured to extrude an adhesive material adjacent to the exposed surfaces of the outer layers 16a, 16b. For example, an adhesive layer may be extruded and applied to an exposed surface of the outer layers 16a, 16b corresponding to a footbed of the sole plate 306, 308 (FIG. 8), whereby the adhesive enables adhesion of the sole plate 306, 308 to an upper (e.g., to the strobel). Optionally, an adhesive layer may be extruded and applied to an exposed surface of the outer layer 16b corresponding to a ground-engaging surface of the sole plate 306, 308, whereby the adhesive enables adhesion of one or more traction elements to the ground-engaging surface of the sole plate 306, 308. In further configurations, the parison 14 may include alternating layers of one or more first copolymer materials and one or more second copolymer materials, where the total number of layers in the parison 14 includes at least four (4) layers, and/or at least ten (10) layers.

In some examples, the materials 12a-12d may include recycled or upcycled materials, which may be obtained from reclaimed scrap of prior extrusions. Recycled material is understood to be distinguishable from “virgin” materials that have never been utilized in a manufacturing process. Upcycled material is understood to be materials that are repurposed without being broken down into raw materials. In configurations utilizing a recycled or reclaimed material, the parison 14 may be formed with three or more layers 16, including the layers 16a, 16b including virgin materials 12a, 12b and an intermediate layer (not shown) including the recycled second material interposed between the inner and outer layers 16a, 16b. Thus, the parison 14 and the resulting sole plates 306, 308 will include a portion of recycled material concealed between virgin material layers 16a, 16b. Thus, the resulting sole plates 306, 308 provide the benefits of using sustainable materials while maintaining the exterior aesthetics associated with virgin materials.

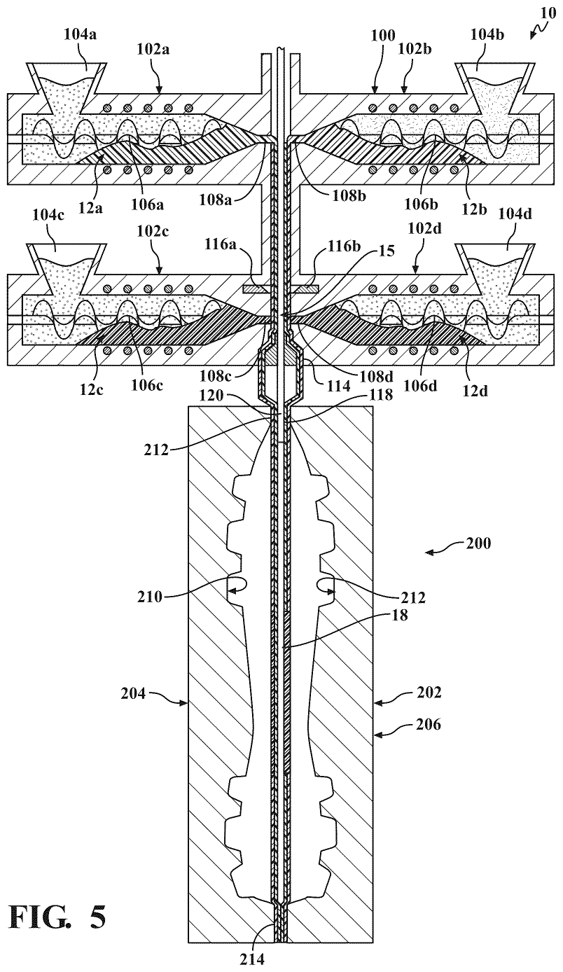

Referring still to FIGS. 1-7, the blow molding system 10 further includes a mold system 200 including a mold assembly 202 operable between an open configuration (FIG. 1) and a closed configuration (FIG. 5). The mold assembly 202 includes a first mold plate 204 and a second mold plate 206, which are configured to interface with each other in the closed configuration to define a mold chamber 208 configured to receive the parison 14. The first mold plate 204 defines a first mold cavity 210 corresponding to the profile of a first sole plate 306 to be molded using the blow molding system 10. The second mold plate 206 defines a second mold cavity 212 corresponding to the profile of a second sole plate 308 to be molded using the blow molding system 10. For example, the mold cavity 210 may define a profile of a sole component 1002 of the article of footwear 1000 (FIG. 15). In the illustrated example, the first mold cavity 210 and the second mold cavity 212 are mirror images of each other, whereby the first mold cavity 210 is configured for molding a first sole plate 306 corresponding to a left-footed article of footwear and the second mold cavity 212 is configured for molding a second sole plate 308 corresponding to a right-footed article of footwear. Thus, the mold assembly 202 is configured to simultaneously mold a pair of the sole plates 306, 308 for a single pair of footwear. In other examples, the mold cavities 210, 212 may have the same configuration (e.g., both left-footed) or may have different profiles (e.g., different sizes, shapes, and/or arrangements of traction elements). Further, while the illustrated example shows mold plates 204, 206 each defining a single mold cavity 210, 212, the mold plates 204, 206 may be configured to include two or more of the mold cavities 210, 212. Further, while the mold cavities 210, 212 of the illustrated example are provided as “female” or negative mold cavities, the mold plates 204, 206 may include “male” or positive mold geometries.

The mold plates 204, 206 are configured to interface with each other in the closed configuration (FIG. 5) to form a peripheral joint 214 that seals around the parison 14. Thus, a peripheral portion of the parison 14 may be compressed between the mold plates 204, 206 when the mold plates 204, 206 are in the closed configuration. As shown, the mold plates 204, 206 are also configured to form a seal between the blow pin 118 and the parison 14 at an entry to the mold chamber 208 to prevent fluid from escaping the mold chamber 208 during the blow molding process.

Referring to FIG. 2A, a first step for forming a molded article 300 according to the present disclosure is shown. In FIG. 2A, the mold assembly 202 is initially provided in the open configuration, whereby the mold plates 204, 206 are spaced apart from each other to open the mold chamber 208. The extrusion system 100 extrudes a first portion 15a of the parison 14 including the inner and outer layers 16a, 16b of the first and second materials 12a, 12b from the first extruder 102a and the second extruder 102b. As shown in FIG. 2A, the interruption elements 116a, 116b are in the retracted position to allow the inner layer 16a and the outer layer 16b to pass through the manifold 112 to the end die 114 uninterrupted. In other words, the inner layer 16a and the outer layer 16b form a continuous cross-section of the parison 14 when the interruption elements 116a, 116b are in the retracted position.

Referring to FIGS. 2B-2E, cross-sections are taken along the length of the manifold 112 to illustrate the progression of the first portion 15a of the parison 14 through the manifold 112 when the interruption elements 116a, 116b are in the retracted position. FIG. 2B provides a first cross-sectional view of the manifold 112 taken downstream of the first nozzle 108a and the second nozzle 108b, whereby the first material 12a and the second material 12b are provided to the manifold 112 to form the inner layer 16a and the outer layer 16b of the parison 14.

FIG. 2C provides a second cross-sectional view of the manifold 112 taken through the interruption elements 116a, 116b. In FIG. 2C, the interruption elements 116a, 116b are shown in the retracted position to allow the parison 14 to pass uninterrupted through the portion of the manifold 112 including the interruption elements 116a, 116b.

FIG. 2D shows a cross-sectional view of the manifold 112 taken downstream of the interruption elements 116a, 116b and upstream of the third and fourth nozzles 108c, 108d of the third and fourth extruders 102c, 102d. Thus, FIG. 2D shows that the parison 14 passes over the retracted interruption elements 116a, 116b without interruption.

FIG. 2E is a cross-sectional view of the manifold 112 taken across the third nozzle 108c and the fourth nozzle 108d of the third extruder 102c and the fourth extruder 102d, respectively. FIG. 2E shows that the third extruder 102c and the fourth extruder 102d do not provide the third material 12c and the fourth material 12d to the manifold 112 in association with portions of the parison 14 formed with the interruption elements 116a, 116b in the retracted position. Thus, the first portion 15a of the parison 14 formed with the interruption elements 116a, 116b in the retracted position passes to the end die 114 without interruptions and is extruded into the mold chamber 208.

Referring now to FIGS. 3A-3F, the blow molding system 10 is shown extruding a second portion 15b of the parison 14 including the third material 12c and the fourth material 12d filling gaps or interruptions formed by the interruption elements 116a, 116b. As shown in FIG. 3A, the first portion 15a of the parison 14 is extruded into the mold chamber 208 while a second portion 15b of the parison 14 passes through the portion of the manifold 112 including the interruption elements 116a, 116b. In this configuration, the interruption elements 116a, 116b are in the extended position to interrupt the flow of the first material 12a and/or the second material 12b through the manifold 112, thereby forming gaps 17a, 17b that are ultimately filled by the third material 12c and the fourth material 12d to form a third layer 16c and a fourth layer 16d. In the illustrated example, a first one of the interruption elements 116a is in a partially extended position to penetrate or interrupt only the outer layer 16b while a second one of the interruption elements 116b is in a fully extended position to penetrate or interrupt both of the outer layer 16b and the inner layer 16a. The interruption elements 116a, 116b are shown in different positions to illustrate different concepts of the disclosure. However, it should be appreciated that both of the interruption elements may be in a partially extended position or a fully extended position.

Referring to FIGS. 3B-3F, cross-sections are taken along the length of the manifold 112 to illustrate the progression of the second portion 15b of the parison 14 through the end die 114 when the interruption elements 116a, 116b are in the extended positions. FIG. 3B provides a first cross-sectional view of the manifold 112 taken downstream of the first nozzle 108a and the second nozzle 108b, whereby the first material 12a and the second material 12b are provided to the manifold 112 to form the inner layer 16a and the outer layer 16b of the parison 14.

FIG. 3C provides a second cross-sectional view of the manifold 112 taken through the interruption elements 116a, 116b. In FIG. 3C, the first interruption element 116a is in the partially extended position to interrupt flow of the outer layer 16b and the second interruption element 116b is in the fully extended position to interrupt the flow of the outer layer 16b and the inner layer 16a, as discussed in the foregoing paragraph.

FIG. 3D shows a cross-sectional view of the manifold 112 taken downstream of the interruption elements 116a, 116b and upstream of the third and fourth nozzles 108c, 108d of the third and fourth extruders 102c, 102d. Thus, FIG. 3D shows that the outer layer 16b is interrupted by the first interruption element 116a to form a first gap 17a along the second portion 15b of the parison 14 and both layers 16a, 16b are interrupted by the second interruption element 116b to form a second gap 17b along the second portion 15b of the parison 14.

FIG. 3E shows that the third extruder 102c and the fourth extruder 102d provide the third material 12c and the fourth material 12d to the manifold 112 in association with portions of the parison 14 formed with the interruption elements 116a, 116b in the extended positions. Thus, a second portion 15b of the parison 14 formed with the first interruption element 116a in the partially extended position includes a third layer 16c including the third material 12c filling the first gap 17a formed through the thickness of the outer layer 16b and on the outside of the inner layer 16a. Similarly, the second portion 15b of the parison 14 formed with the second interruption element 116b in the fully extended position includes a fourth layer 16d including the fourth material 12d filling the second gap 17b formed through the thickness of the inner layer 16a and the outer layer 16b. FIG. 3F shows the resulting second portion 15b of the parison 14 where the third layer 16c and the fourth layer 16d cooperate with the inner layer 16a and the outer layer 16b to form a continuous parison 14.

As discussed previously, the third material 12c and the fourth material 12d may have different performance and/or aesthetic properties than the first material 12a and/or the second material 12b. For example, the third material 12c forming the partial-depth third layer 16c may have a different color than the second material 12b to form a stripe or other aesthetic feature along the outer layer 16b of the sole plate 306, 308. In another example, the fourth material 12d forming the full-depth fourth layer 16d may be translucent or transparent to provide for a viewing window through the thickness of the sole plate 306, 308. Such a viewing window may be useful for providing visibility of interior layers of the article of footwear 1000.

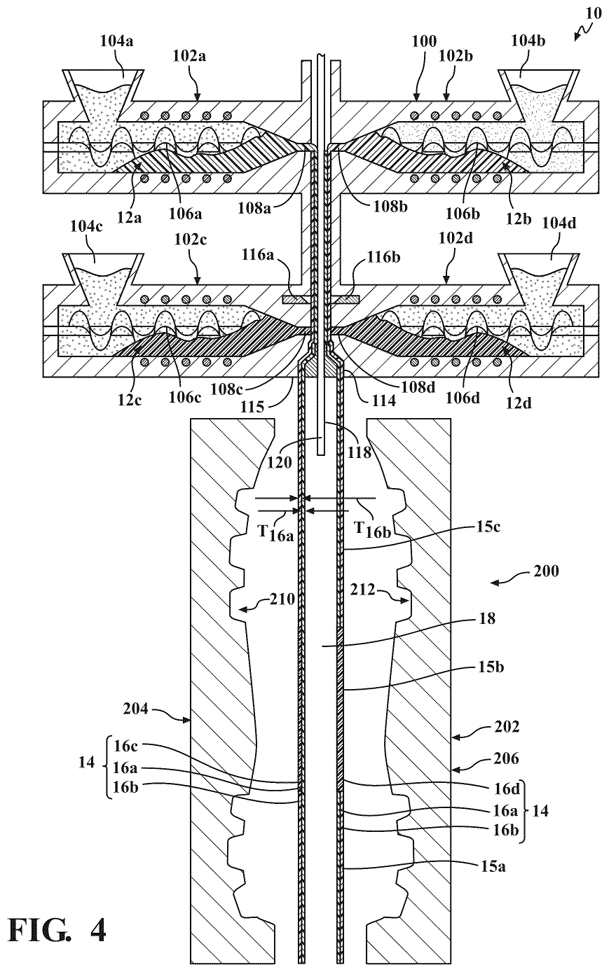

At FIG. 4, the interruption elements 116a, 116b are returned to the retracted position and an uninterrupted third portion 15c of the parison 14 is extruded into the mold cavity 210 along with the uninterrupted first portion 15a and the interrupted second portion 15b. At FIG. 5, the mold assembly 202 is moved to the closed configuration to form the peripheral joint 214 that seals around the parison 14. As shown, the distal end of the parison 14 is compressed between the mold plates 204, 206 to seal the interior cavity 18 at the distal end of the parison 14. Concurrently, the mold plates 204, 206 interface at a proximal end (i.e., adjacent to the end die 114) of the parison 14 to form the peripheral joint 214 along the periphery of the parison 14 and the blow pin 118. Thus, at FIG. 5, the parison 14 is sealed at each of the distal end and the proximal end, whereby fluid can be introduced into the interior cavity 18 of the parison 14 via a conduit 120 of the blow pin 118 to expand the parison 14 into the mold plates 204, 206.

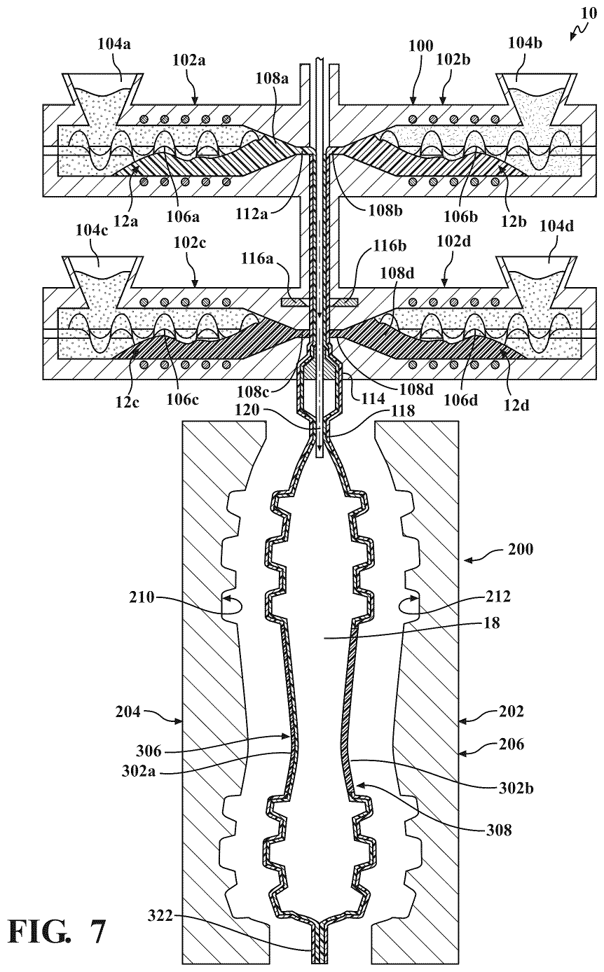

At FIG. 6, compressed air A or other pressurized fluid is introduced into the interior cavity 18 of the parison 14 via the blow pin 118 to bias the layers 16a-16d of the materials 12a-12d of the parison 14 outwardly and into the respective mold cavities 210, 212. As shown, the mold cavities 210, 212 of the illustrated example are configured to form a molded article 300 including sole plates 306, 308 having molded traction elements 314. Particularly, the first mold cavity 210 is configured to form a first sole plate 306 including a first sole plate body 310 and a plurality of the traction elements 314. The second mold cavity 212 is configured to form a second sole plate 308 including a second sole plate body 312 and a plurality of the traction elements 314. At FIG. 7, the mold assembly 202 is moved to the open configuration so that the molded article 300 including the sole plates 306, 308 can be cooled and removed from the mold chamber 208.

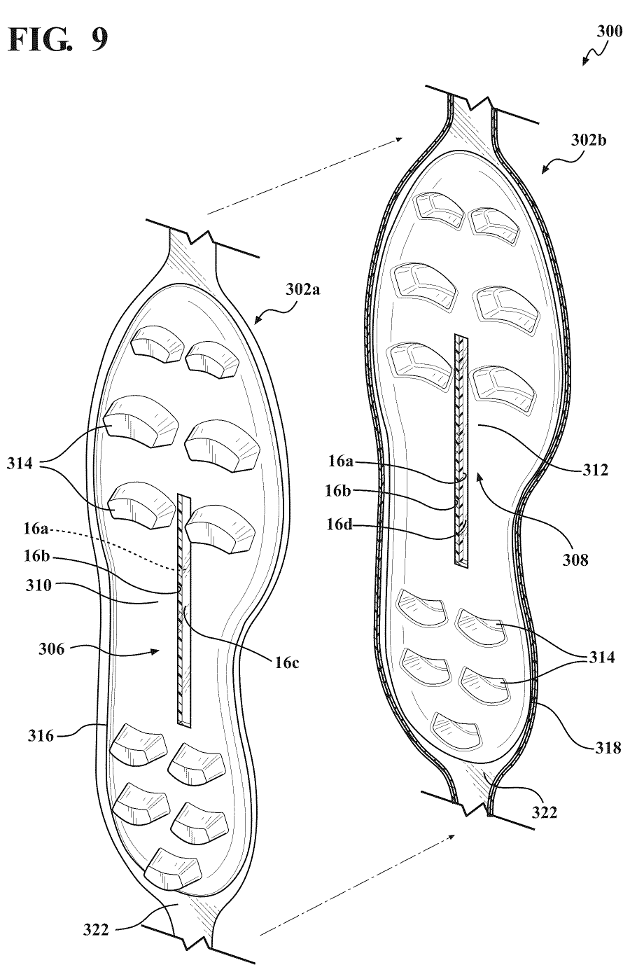

Referring to FIG. 8, the molded article 300 is shown after removal from the mold chamber 208. In this example, the molded article 300 includes a plurality of molded article sections 302a, 302b corresponding to the number of mold plates 204, 206 (FIG. 7). Thus, the molded article 300 may include a first molded article section 302a and a second molded article section 302b joined to each other at molded article seams 304a, 304b corresponding to the joints between the mold plates 204, 206. The first molded article section 302a includes the first sole plate 306 and material flashing 322 associated with excess material of the parison 14. The second molded article section 302b includes the second sole plate 308 and material flashing 322 associated with excess material of the parison 14. As shown, the molded article seams 304a, 304b are formed within the material flashing 322 between adjacent ones of the molded article sections 302a, 302b. Optionally, the molded article sections 302a, 302b may be separated from each other along the molded article seams 304a, 304b by cutting or manually pulling apart the molded article sections 302a, 302b. FIG. 9 shows the molded article 300 in a separated state including the first molded article section 302a and the second molded article section 302b.

As shown, the sole plates 306, 308 each include the layers 16a-16d of the parison 14, which cooperate to define the structure of the sole plate 306. The illustrated sole plate 306 includes a first sole plate body 310 and a plurality of traction elements 314, each including the layers 16a, 16b. Again, while the illustrated examples of the sole plates 306, 308 are provided with two layers 16a, 16b forming the main body 310, any number of material layers may be incorporated into the sole plates 306, 308 by selecting a corresponding extrusion system 100 for forming a parison 14 with the desired layer configuration. The sole plate 306 further includes the partial-depth third layer 16c forming the stripe along an intermediate portion of the sole plate 306. The sole plate 308 includes the full-depth fourth layer 16d extending through the thickness of the sole plate 308 to form a window through the sole plate 308.

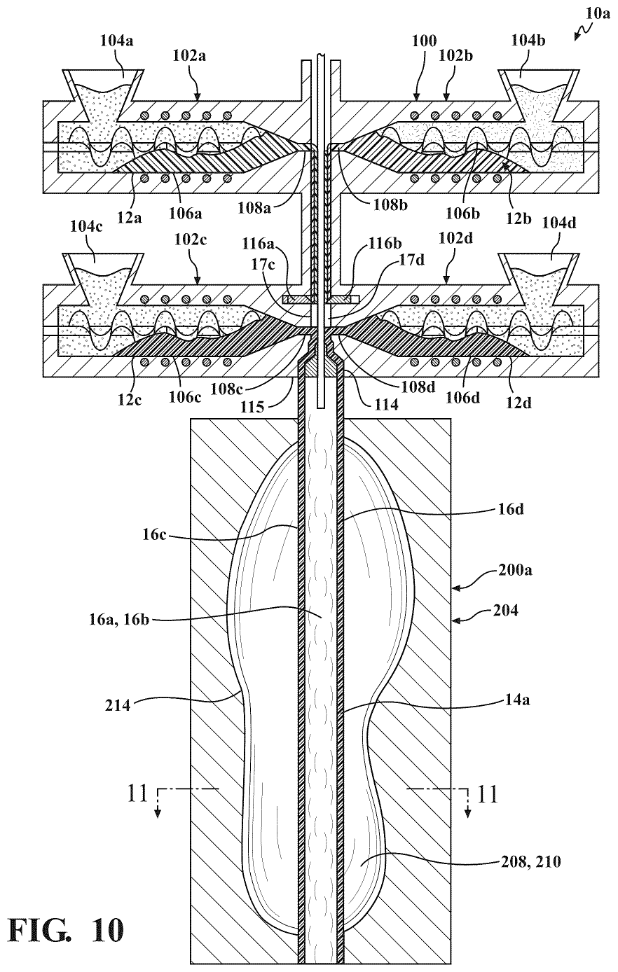

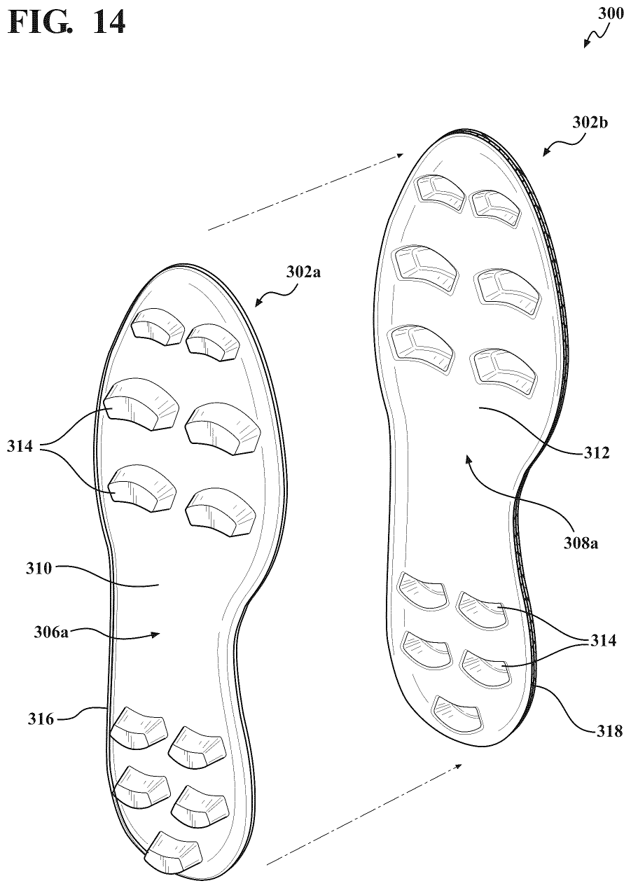

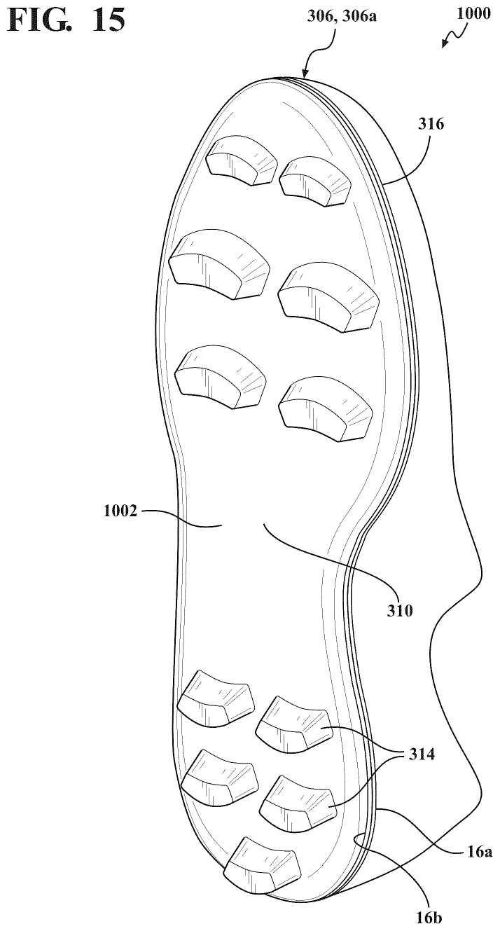

Referring now to FIGS. 10-14, another example of a blow molding system 10a is provided and includes the extrusion system 100 and a mold system 200a. In view of the substantial similarity in structure and function of the components associated with the blow molding system 10 with respect to the blow molding system 10a, like reference numerals are used hereinafter and in the drawings to identify like components while like reference numerals containing letter extensions are used to identify those components that have been modified.

The blow molding system 10a is substantially similar to the blow molding system 10 described previously except that the mold system 200a is rotated ninety degrees about an extrusion axis associated with the end die 114. Thus, the third layer 16c and the fourth layer 16d are oriented towards a peripheral portion of the mold system 200a where the first mold plate 204 and the second mold plate 206 interface with each other to form a peripheral joint 214 that seals along a periphery of the parison 14a when the parison 14a is expanded into the mold cavity 210. As shown in FIG. 10, the parison 14a is continuously extruded with the interruption elements 116a, 116b in the fully extended position such that the inner layer 16a and the outer layer 16b are fully interrupted along the interruption elements 116a, 116b to form first and second full-depth gaps 17c, 17d. In this example, the third material 12c is provided along the entire length of the parison 14a on a first side oriented towards a lateral side joint of the mold assembly 202 and the fourth material 12d is provided along the entire length of the parison 14a on a second side oriented towards a medial side joint of the mold assembly 202.

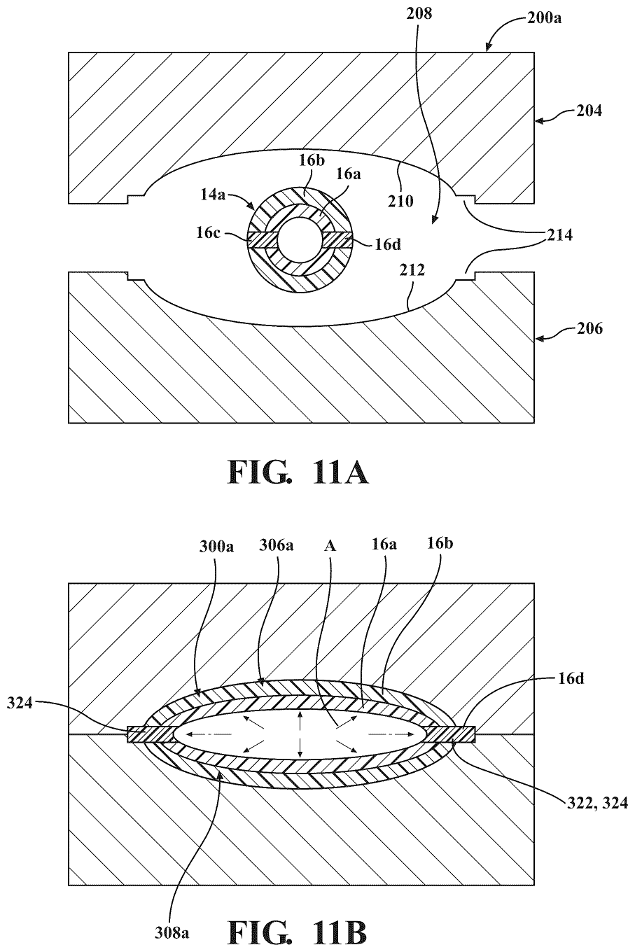

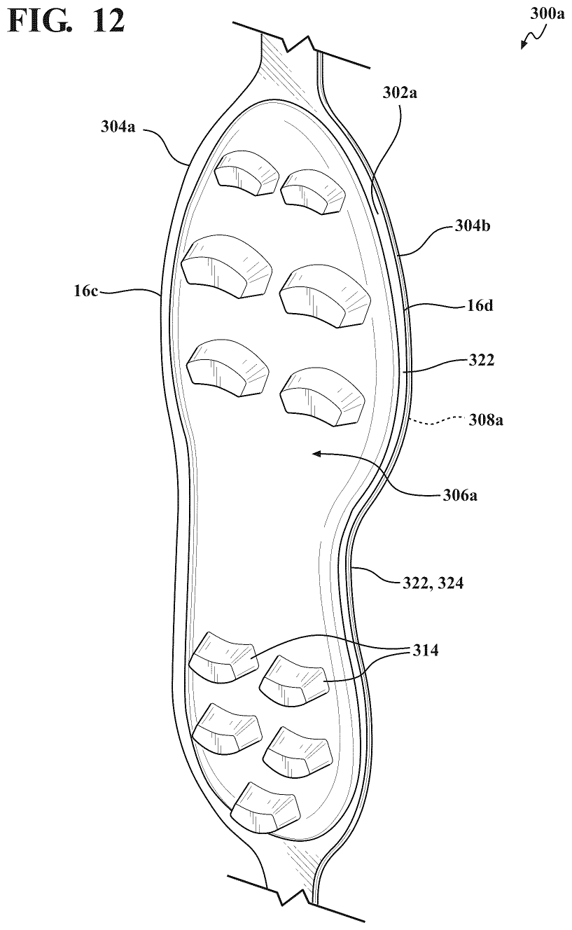

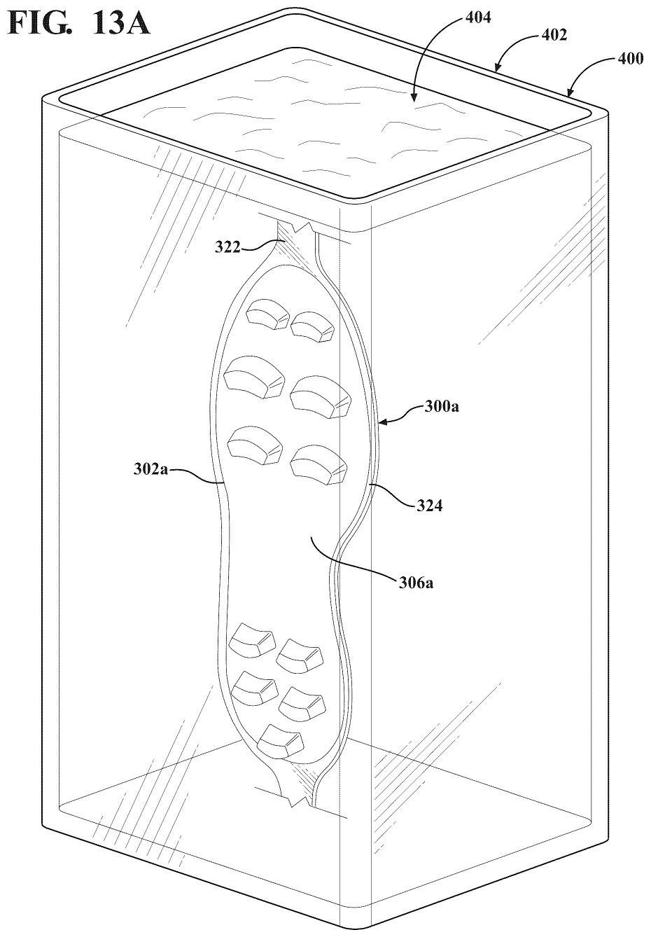

Referring to FIGS. 11A and 11B, cross-sectional views of the mold system 200a are provided showing the relative orientation of the parison 14a within the mold assembly 202. As shown in FIG. 11A, the mold assembly 202 is provided in the open configuration while the parison 14a is extruded into the mold chamber 208. Here, the inner layer 16a and the outer layer 16b are oriented towards the respective mold cavities 210, 212 of the mold plates 204, 206 while the third layer 16c and the fourth layer 16d are oriented towards the peripheral joint 214 of the mold assembly 202. At FIG. 11B, the mold assembly is moved to the closed configuration and the parison 14a is expanded into the mold chamber 208 by injecting air A or other pressurized fluid into the interior cavity 18 of the parison 14a. In this example, expanding the parison 14a causes the third layer 16c and the fourth layer 16d to expand into the peripheral joint 214 to form the mold flashing 322.

The third material 12c and the fourth material 12d are provided as separation materials that are configured to be easily separated or removed to allow the sole plates 306a, 308a to be easily separated from each other after molding. For example, the third material 12c and the fourth material 12d may be materials that do not adhere with the first material 12a and/or the second material 12b, such that the third material 12c and the fourth material 12d may be peeled or otherwise manually removed from the molded article 300a. In other examples, the third material 12c and the fourth material 12d may be a dissolvable and/or water-soluble material, such as a polyvinyl alcohol or other similar materials. The third material 12c and the fourth material 12d are thus dissolvable using a variety of solvents including, but not limited to, water and/or acids, such that the solvent may be applied to the third material 12c and the fourth material 12d to remove them from the sole plates 306a, 308a. In other examples, the third material 12c and the fourth material 12d may include materials having a relatively low durometer compared to the first material 12a and the second material 12b, whereby the third material 12c and the fourth material 12d can be easily cut using a cutting tool. Thus, the mold flashing 322 may function as a separation flange 324 along which the sole plates 306a, 308a can be separated from each other. FIG. 12 shows an example of the molded article 300a including the first and second sole plates 306a, 308a joined together along the separation flange 324 formed by the third layer 16c and the fourth layer 16d.

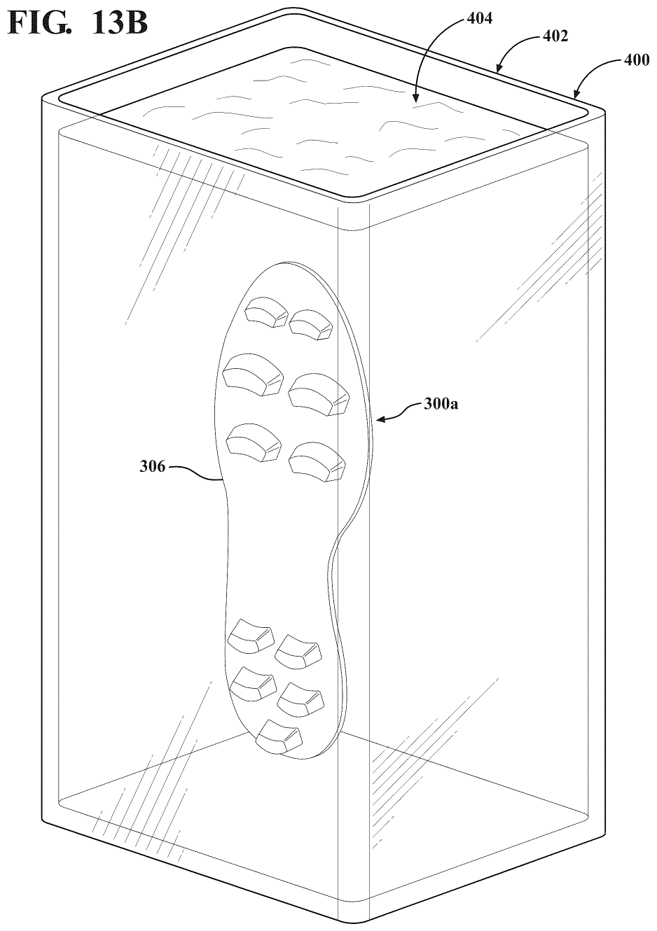

Referring to FIG. 13A, an example of the molded article 300a formed with a dissolvable separation flange 324 is shown being processed through a rinsing system 400 illustrated in a rinsing process during which the molded article 300a is submerged within a basin 402 or otherwise rinsed using a liquid 404, such as water or solvent to separate the first sole plate 306a from the second sole plate 308a. The rinsing process is utilized when the third layer 16c and the fourth layer 16d are formed from a dissolvable material (e.g., 12c and 12d). During the rinsing process, the third layer 16c and the fourth layer 16d are dissolved from the molded article 300a, which results in the separation of the first sole plate 306a from the second sole plate 308a. As mentioned above, the molded article 300 includes a plurality of molded article sections 302a, 302b corresponding to the number of mold plates 204, 206 (FIG. 7). Thus, the molded article 300a includes the first molded article section 302a and the second molded article section 302b.

As a result of the rinsing process, the separation flange 324 dissolves and the first sole plate 306a is separated from the second sole plate 308a, as shown in FIG. 13B. In this step, the first sole plate 306a is separated from the first molded article section 302a by removing the mold flashing 322 from a first plate body periphery 316, and the second sole plate 308a is separated from the second molded article section 302b by removing the mold flashing 322 from a second plate body periphery 318. As shown, the first sole plate 306a includes only the inner and outer layers 16a, 16b of the parison 14, which cooperate to define the structure of the sole plate 306a. The illustrated sole plate 306a includes a first sole plate body 310 and a plurality of traction elements 314, each including the layers 16a, 16b. Again, while the illustrated examples of the sole plates 306a, 308a are provided with two layers 16a, 16b, any number of material layers may be incorporated into the sole plates 306a, 308a by selecting a corresponding extrusion system 100 for forming a parison 14 with the desired layer configuration. Additionally or alternatively, thicknesses T₁₆ₐ, T_{16b} of the layers 16a, 16b may be varied and/or the layers 16a, 16b may be intermittently provided in independent zones of the sole plates 306a, 308a. FIG. 15 illustrates an article of footwear 1000 equipped with the sole plate 306a as a sole component 1002. Alternatively, the article of footwear 1000 may include any one of the sole plates 306, 308, 308a disclosed herein.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A blow molding system comprising:
an extrusion system including a first extruder suitable to extrude a first material to a manifold having an end die to form a first layer of a parison;
one or more interruption elements each disposed within the manifold between the first extruder and the end die, each of the one or more interruption elements moveable between a retracted position spaced apart from the first material and an extended position penetrating a flow of the first material to form a respective gap in the parison; and
a mold assembly including a mold chamber defining a profile of at least one mold plate defining a mold cavity and including a mold opening suitable to receive the parison from the end die of the first extruder.

2. The blow molding system of claim 1, further comprising a second extruder suitable to extrude a second material into the one or more gaps.

3. The blow molding system of claim 2, wherein the second material is a water-soluble material.

4. The blow molding system of claim 2, wherein the second material is a transparent or translucent material.

5. The blow molding system of claim 2, wherein the second material has a lower durometer than the first material.

6. The blow molding system of claim 2, wherein the one or more interruption elements include a first interruption element moveable to the extended position to form a first gap and a second interruption element moveable to the extended position to form a second gap.

7. The blow molding system of claim 6, wherein the second extruder extrudes the second material into a first one of the one or more gaps, and further comprising a third extruder suitable to extrude a third material into a second one of the one or more gaps.

8. The blow molding system of claim 1, wherein the mold chamber includes a plurality of mold cavities each facing the mold chamber and defining a profile of at least one sole component of an article of footwear.

9. The blow molding system of claim 1, further comprising a fourth extruder extruding a fourth material to form a second layer of the parison concentric with the first layer.

10. The blow molding system of claim 1, wherein the one or more interruption elements are aligned with an intermediate portion of the mold cavity of the at least one mold plate.

11. A method comprising:
providing a first material from a first extruder to a manifold to form a first layer of a parison flowing through the manifold;
partially interrupting a flow of the first layer through the manifold to form a gap in the first layer;
providing a second material from a second extruder into the gap formed in the first layer; and
extruding the parison including the first material and the second material into a mold chamber having an opening at one end that receives the parison, the mold chamber including at least one mold cavity facing the mold chamber and defining a profile of at least one sole component of an article of footwear.

12. The method of claim 11, wherein the gap is aligned with an intermediate portion of the at least one mold cavity.

13. The method of claim 11, wherein the gap is aligned with a peripheral portion of the at least one mold cavity.

14. The method of claim 11, wherein interrupting the flow of the first material includes moving an interruption element from a retracted position spaced apart from the first layer to an extended position penetrating the first layer.

15. The method of claim 11, wherein the second material is a water-soluble material.

16. The method of claim 11, wherein the second material is a transparent or translucent material.

17. The method of claim 11, wherein the second material has a lower durometer than the first material.

18. The method of claim 11, further comprising providing a third material from a third extruder to the manifold to form a second layer of the parison concentric with the first layer.

19. The method of claim 11, wherein interrupting the flow of the first layer includes interrupting a first portion of the flow of the first layer and a second portion of the flow of the first layer to define a first gap and a second gap in the first layer.

20. The method of claim 19, wherein providing the second material includes providing the second material into each of the first gap and the second gap.
